(19) United States
(12) Patent Application Publication
(10) Pub. No.: US 2016/0278516 A1
(43) Pub. Date: Sep. 29, 2016

(54) PRODUCT SHIPPING SYSTEM

(71) Applicant: James Lawrence, Chipley, FL (US)

(72) Inventor: James Lawrence, Chipley, FL (US)

(21) Appl. No.: 14/669,311

(22) Filed: Mar. 26, 2015

(51) Int. Cl. A47B 43/00; B65G 67/04

(52) U.S. Cl. CPC A47B 43/00; B65G 67/04

(57) ABSTRACT

An efficient system for loading and unloading freight from the manufacturing site or warehouse to the end user with a minimum of freight handling employs an intermodal freight rack (IFR) that may be loaded with products requiring at least one handling step per product and transported in a single handling step to a staging area. At the staging area the loaded IFR is transferred in a single handling step to a carrier for transport to a destination staging area where the loaded IFR is removed in a single step from the carrier and then transported to the end user site in a single step for unloading. Empty IFRs can be collapsed and stacked for return to the origin site.

### FIELD OF THE INVENTION

This invention relates to the field of product shipping and more particularly to system and apparatus for loading and unloading products on a carrier.

### BACKGROUND OF THE INVENTION

It is common in the shipment of products or materials on a carrier, particularly flatbed trailers for the product to be pulled from warehouse or manufacturing floor via crane, forklift or other means to a staging area usually near the trailer. The product is then meticulously loaded onto the trailer and depending on number of various items loaded such loading process can be labor intensive. After loading and securing freight for transport the trailer is pulled to a destination which in many cases is a distribution center. At the distribution center, the reverse activity is accomplished which is again a time consuming and labor intense operation. In total, from manufacturing/warehouse to rest at distribution center, there are at least four “touches or handling” points.

Not only does each “touch” add to the expense of shipping products but also each touch increases the time it takes to load and unload items. The total effect is to increase the shipping time for a trailer load. In the current shipping environment time between order and delivery has become a critical marketing factor and companies strive to make product shipment as efficient and rapid as possible.

Accordingly, it is highly desirable to have apparatus and a system that makes product loading more efficient and less costly by reducing the number of “touches” required to load a carrier to make the process more rapid and reduce the labor intensity required by standard shipping systems.

### SUMMARY OF THE INVENTION

The invention will be described hereinafter in connection with the loading and unloading of flatbed trailers and to the freight racks designed for use in the system of the invention that are referred to as Intermodal Freight Racks (IFR). It should be understood, however, the invention is applicable to other types of carriers such as conventional semi-trailers, trucks, rail cars, ships and the like.

In accordance with the invention the system employs an IFR comprising a rectangular frame consisting of two longitudinal rails defining the length of the frame and a lateral member at each end of the longitudinal rails defining the width of the frame. One or more longitudinal strings extend between the lateral members and are spaced inwardly of the longitudinal rails. Two or more laterally extending cross struts are positioned between the longitudinal rails to add rigidity to the frame. The cross struts are provided with cut away areas corresponding with the position of the longitudinal strings for receiving and nesting over the longitudinal rails.

An elongated member is pivotally connected to the rectangular frame adjacent each corner for movement between an upright position normal to the longitudinal rails and a folded position parallel to the rails. In the upright position the elongated member defines an upwardly extending arm for supporting and securing items being shipped. The elongated member below the pivot point defines a downwardly depending leg for support of the frame above a surface such as the floor of the flatbed trailer. This allows for the storage of flat items below the racks. When the arms are pivoted into the folded position the racks can be stacked for empty return and easy storage at a warehouse or manufacturing site.

The IFRs are positioned on the manufacturing floor or warehouse sorting floor with the pivotal arms normally in the upright position. Freight items are loaded directly on the IFR. Preferably each IFR carries freight to be delivered to the same destination. The freight is secured on the IFR in accordance with DOT regulations using straps and D rings or other attachment points provided on the IFR.

The loaded IFR is loaded onto the flatbed trailer by forklift using built in fork lift pockets in the longitudinal rail or by crane from four hoist points provided on the IFR and secured on the trailer by straps or by securing the depending portion of the pivotal arms in pockets provided on the trailer. The loaded flatbed trailer is then pulled to destination which could be distribution center or the end user of the freight. When it is received at destination the IFR's are untied from trailer and in three motions with crane or forklift all the freight is removed from trailer. The net result is reduced handling by 50% or greater.

The present invention provides a system for loading and unloading freight that is efficient and that reduces man hours and time in the handling of freight. The system of the invention provides substantial cost savings at both the origin and destination. The IFR allows low profile freight to be placed below the IFR thus making better utilization of the carrier. In addition the IFR's are normally preloaded thus reducing wait time for trucks and drivers.

These and other advantages of the present invention will become more apparent from the following description of the preferred embodiments taken in conjunction with the following drawings.

### DESCRIPTION OF THE DRAWINGS

FIG. 1 is a flow chart illustrating the steps normally required to ship products;

FIG. 2 is a plan view of a collapsible IFR in accordance with the invention;

FIG. 3 is an elevation taken through line 3-3 of FIG. 2;

FIG. 4 is an elevation taken through line 4-4 of FIG. 2;

FIG. 5A is a side elevation showing racks in accordance with the invention on a flatbed trailer with the pivotal arms in the upright position; and

FIG. 5B is a side elevation of a flatbed trailer fully loaded with empty IFR's with the pivotal arms in the folded position for return to the shipper.

### DESCRIPTION OF THE PREFERRED EMBODIMENTS

For purposes of description and illustration of the invention the system will be described in connection with a manufacturer and distributor of a variety of metal products such as, for example, steel pipe and tubing, bar stock, formed sections, valves and fittings. Shipping such a diverse group of products requires individual handling (touching) of the products themselves or, for smaller items, handling boxes containing the items.

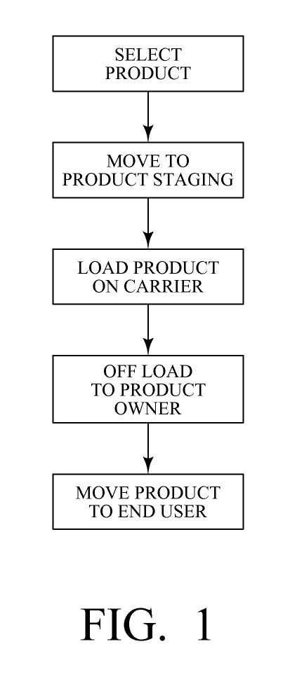

Referring to FIG. 1 the steps normally required in shipping products from an origination site, such as a manufacturer or a warehouse to an end user of the products is illustrated. Thus the shipping procedure, as summarized in Table 1 below, will include: (i) selecting the product for shipping; (ii) transferring the selected product to a staging point for loading on a carrier; (iii) loading the product on a carrier; (iv) off-loading the product at the destination; and moving the product to the end user. Each step in the shipping process requires that the products be handled. Each handling step, be it by hand, fork lift or other machine is referred to as a “touch” and each touch will involve the expenditure of time as well as the cost of personnel and/or machine cost.

For example, shipping 60 items of diverse description by flatbed trailer requires that the items be individually handled (touched) from inventory to freight staging area for loading onto a carrier. Loading onto the carrier requires another 60 touches. At the destination the reverse operation requires another 120 touches from the cattier to end user. Thus, shipping 60 items by conventional methods will require a total of 240 touches.

With the system of the present invention using the novel collapsible IFR a fully loaded flatbed trailer, normally 48-53 feet in length can preferably handle three IFR's for minimum touches (for example two 20 foot and one 10 foot IFR). Assuming the same 60 items comprises a full load for the flatbed trailer, 60 touches are required to load 3 IFR's. Moving the IFR's to the product staging area requires only 3 touches, one touch for each IFR, and loading the IFR's requires 3 touches. Similarly the reverse operation at the destination will also require 66 touches for a total of 123 touches.

Each touch involves manpower and the expenditure of time and cost. With the present invention a flatbed trailer can loaded or unloaded in minutes compared to several hours conventional loading and unloading. Most of the product handling occurs at the manufacturing site or at the warehouse.

Table 1 summarizes and compares conventional loading to the inventive system utilizing the IFR's.

TABLE 1
Number of Steps or Touches Required for Product Handling

| Steps or Touches | Conventional System | IFR |
|---|---|---|
| Product from Freight | 60 | 60 |
| Origination Site to staging | | |
| Load product on carrier | 60 | 3 |
| Product from carrier to | 60 | 3 |
| destination staging queue | | |
| Product from queue to | 60 | 60 |
| Shelf or End User | | |
| Total Touches | 240 | 123 |

As can be seen the system of the invention reduces product handling, especially during loading and unloading of the trailer. The time, manpower and cost of shipping products are substantially reduced. In addition due to faster loading truck waiting time at the origin and destination is cut, further improving the efficiency of product shipping by the system of this invention.

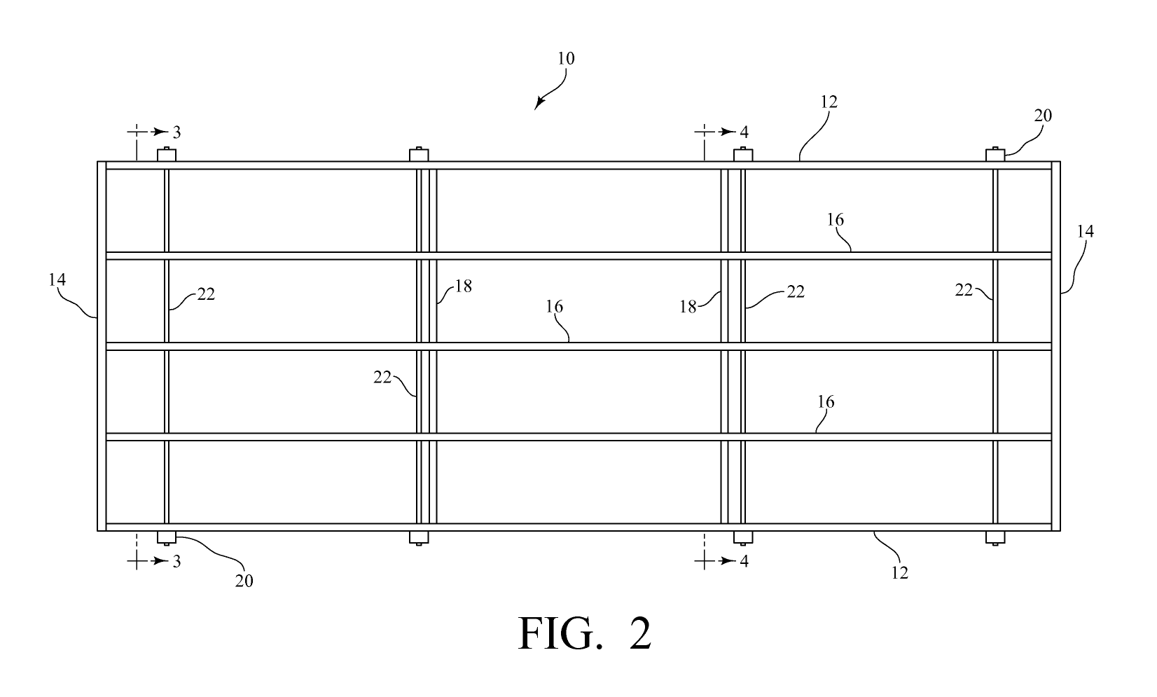

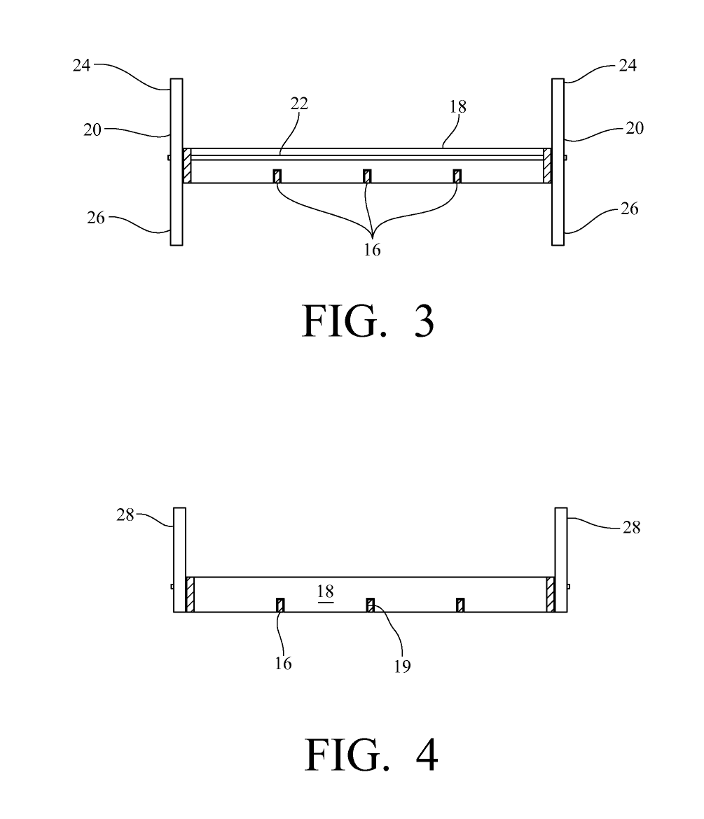

Referring to FIG. 2 the system employs an IFR 10 comprising a rectangular frame consisting of two longitudinal rails 12 defining the length of the frame and a lateral member 14 at each end of the longitudinal rails defining the width of the frame. One or more longitudinal reinforcing stringers 16 extend between the lateral members and are spaced inwardly of the longitudinal rails 12. Two or more lateral cross struts 18 extend between the longitudinal rails 12 intermediate the ends thereof to add rigidity to the frame. As shown in FIG. 4 the cross struts 18 are provided with cut away areas corresponding with the position of the longitudinal strings for receiving and nesting over the longitudinal rails 16.

An elongated member 20 is pivotally connected by rods 22 to the longitudinal rail 12 adjacent each corner of the frame for pivotal movement between an upright position normal to the longitudinal rails and a folded position parallel to the rails. In the upright position the elongated member defines an upwardly extending arm 24 to support and secure items being shipped. The elongated member further defines a depending portion comprising the lower part of the member below the pivot point to define a leg 26 for supporting the frame above the floor of the carrier. This allows for the storage of flat items below the racks.

Opposed pairs of intermediate pivotal members 28 can be positioned along the longitudinal rails as a further aid in supporting and securing freight on the rack. The intermediate members normally comprise only the arm 24 but depending on the number and location along the frame the member 28 may also include the depending support leg 26.

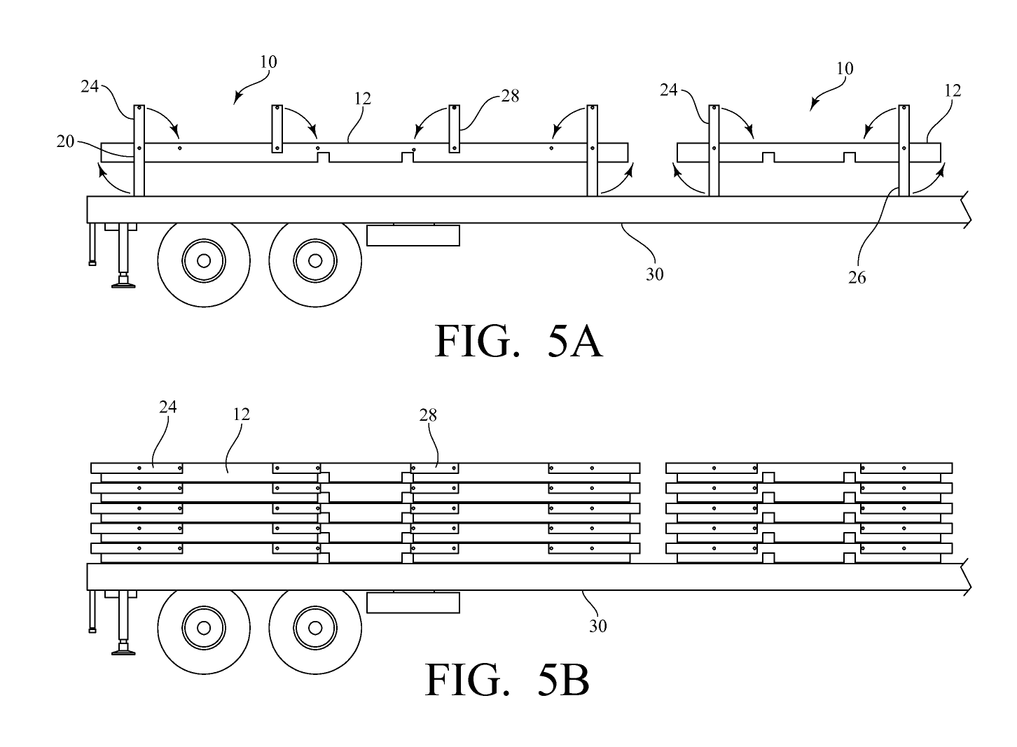

FIG. 5A illustrates IFRs 10 positioned on a flatbed trailer 30 with elongated members 20 pivoted into the extended position to define the extending arm 24 and the support leg 26 to maintain the IFR above the bed of the trailer.

Items can be secured on the rack by cargo straps or cable pursuant to DOT procedures and suitable tie down cleats or D-rings or the like can be disposed on the arm portion of the elongated member and along the longitudinal rails for securing the items. The IFR can be loaded onto the carrier by a forklift and for this purpose the longitudinal rails 12 may be adapted to receive the tongs of the forklift as shown in FIG. 5A. In addition the rack may also be provided with suitable hoist points, such as for example lifting rings (not shown) for movement of the loaded rack by a crane.

In many cases the IFR's will be returned empty to the origination location. Although this is a necessary operation, it will be seen that this is a nonproductive expense that must be factored into the cost of shipping products. Conventional pallets are often destroyed at the destination or otherwise not returned to the originating site and the shipper must bear the cost of replacing the pallets.

Referring to FIG. 5B, the arms can be pivoted to a folded position to lie essentially in the same plane as the frame. When collapsed with the arms in the folded position seven IFR's occupy the cubic space of one un-collapsed IFR. Thus the IFR's can be stacked for storage in a minimum of space. As illustrated in FIG. 5B, the collapsed IFR's can be conveniently stacked on a carrier, such as the flatbed trailer 30, for economical return to the shipper.

From the foregoing description and drawings it will be seen that the present invention provides an efficient time and cost saving system for shipping products such as raw materials, finished and unfinished products, larger volume packages and the like from the origination point to the end user. The system employs a novel intermodal flatbed rack (IFR) which can be loaded at the floor of a manufacturing site or warehouse floor and be loaded and unloaded with all the products with only a single touch per IFR. The IFR's are collapsible for storage in a minimum of space and for convenient empty return.

1. A system for efficiently loading and unloading freight comprising:
a. locating an intermodal freight rack at a freight origination site;
b. placing a plurality of freight items to be shipped to a single destination on said intermodal freight rack;
c. moving said collapsible rack in a single handling step to a product staging area for assignment to a carrier;
d. loading said intermodal freight rack onto said carrier in a single handling step for transport to a destination site;
e. at said destination site offloading said intermodal freight rack in a single handling step;
f. transporting said intermodal freight rack in a single handling step to an end user site; and
g. removing said plurality of freight items from said collapsible rack;
wherein said intermodal freight rack is defined by a rectangular frame member, a pivotal member disposed on said frame member adjacent each corner thereof for movement between an upright position perpendicular to said frame member and a folded position parallel to said frame.

2. The system of claim 1 wherein said pivotal member in the upright position defines an upwardly extending arm portion for supporting and securing items on said rack.

3. The system of claim 1 wherein said pivotal member in the upright position defines a downwardly depending leg portion for supporting said rack above a surface.

4. The system of claim 1 wherein said frame member comprises two longitudinal rails defining the length of said frame member and a lateral end member extending perpendicularly between said longitudinal rails at each end thereof and defining the width of said frame member, at least one longitudinal reinforcing stringer within said frame member extends between said lateral end members the length of said frame, at least one cross strut extends normal to and connects said longitudinal rails at a point intermediate said lateral end members, said cross strut having a cut away for receiving and nesting over said longitudinal reinforcing stringer.

5. The system of claim 4 wherein said pivotal members are pivotally connected to said longitudinal rails adjacent the corners of said frame member.

6. The system of claim 4 wherein an opposed pair of intermediate members are pivotally connected to said longitudinal rails to define in the upright position an extending arm portion for supporting and securing items on said rack.

7. The system of claim 4 wherein said intermediate members in the upright position define a downwardly depending leg portion for supporting said rack above a surface.
